(19) United States
(12) Patent Application Publication
(10) Pub. No.: US 2025/0210248 A1
(43) Pub. Date: Jun. 26, 2025

(54) SURFACE MOUNT COIL COMPONENT

(71) Applicant: SUMIDA CORPORATION, Tokyo (JP)

(72) Inventor: Takeshi HATAKEYAMA, Natori City, Miyagi (JP)

(21) Appl. No.: 18/849,754

(22) PCT Filed: Mar. 29, 2022
(86) PCT No.: PCT/JP2022/015643

§ 371 Date: Sep. 23, 2024

(51) Int. Cl. H01F 27/29; H01F 27/32

(52) U.S. Cl. CPC H01F 27/292; H01F 27/325

(57) ABSTRACT

Provided is a surface mount coil component comprising: a winding wire with a lead portion; an insulating bobbin with a winding shaft portion for the winding wire; a plurality of mounting terminals protruding from the bobbin; and a plurality of entangling terminals which are formed from the same member as each of the mounting terminals and which are used to entangle the lead portion of the winding wire. A plurality of adjacent entangling terminals are bent with respect to the direction of protrusion from the bobbin; the lead portion is entangled on the bent portions of the entangling terminals.

### TECHNICAL FIELD

The present invention relates to a surface mount coil component.

### BACKGROUND ART

With recent shift towards higher switching frequency, switching transformers have been required to be downsized.

From the viewpoint of achieving good reliability, a widely adopted structure has provided therein mounting terminals and separate entwined terminals, such as those in a surface mount transformer described in Patent Literature 1.

### CITATION LIST

### Patent Literature

[Patent Literature 1] JP 2007-214528 A

### SUMMARY OF THE INVENTION

### Technical Problem

The structure of the surface mount transformer described in Patent Literature 1 needs to reserve an insulation distance enough to achieve a required voltage resistance, for which a pitch between the entwined terminals, for example, of approximately 2 mm has been required in order to avoid interference with a nozzle of an automatic winder, when automatization of the manufacturing line is taken into consideration.

Such requirement for the necessary pitch between the entwined terminals has been a particular issue to be solved in order to downsize the surface mount coil component.

The present invention was conceived in consideration of the aforementioned problem and is to provide a surface mount coil component allowed for downsizing.

### Solution to Problem

According to the present invention, there is provided a surface mount coil component which includes a winding having a lead section; an insulating bobbin having a winding base for the winding; a plurality of mounting terminals protruded out from the bobbin; and a plurality of entwined terminals formed of the same member with the individual mounting terminals, around which the lead section of the winding is wound, adjacent entwined terminals of the plurality of entwined terminals being bent facing to a direction of protrusion from the bobbin, and the lead section being wound around each bent part of each of the entwined terminals.

### Advantageous Effects of Invention

The present invention can provide a surface mount coil component allowed for downsizing.

### BRIEF DESCRIPTION OF DRAWINGS

FIG. 1 is a perspective view illustrating a surface mount transformer of this embodiment.

FIG. 2 is an enlarged view of a part II in FIG. 1, illustrating adjacent entwined terminals.

FIG. 3 is a top perspective view illustrating a bobbin.

FIG. 4 is a bottom perspective view illustrating the bobbin.

### DESCRIPTION OF EMBODIMENTS

Embodiments of the present invention will be explained below referring to the attached drawings.

The embodiments explained below are merely exemplary ones for the convenience of easy understanding of the present invention, without limiting the present invention. That is, shape, dimension, arrangement and so forth of the components described below may be changed or modified without departing from the spirit of the present invention, so that the present invention may of course encompasses the equivalents thereof.

Also note that various constituents of the present invention are not always necessarily independent from each other, instead allowing that a plurality of constituents are constituted as a single constituent; that a single constituent is formed while being divided into a plurality of constituents; that a certain constituent is a part of other constituent; and that a part of a certain constituent and a part of the other constituent are shared.

Also note that all similar constituents will have similar reference signs in all drawings, so as to avoid redundant explanation. In these embodiments, mounting direction is laid in the downward direction, and the opposite direction is laid in the upward direction, which are however not necessarily coincide with the upward and downward directions in terms of gravity.

### <Outline of Surface Mount Coil Component>

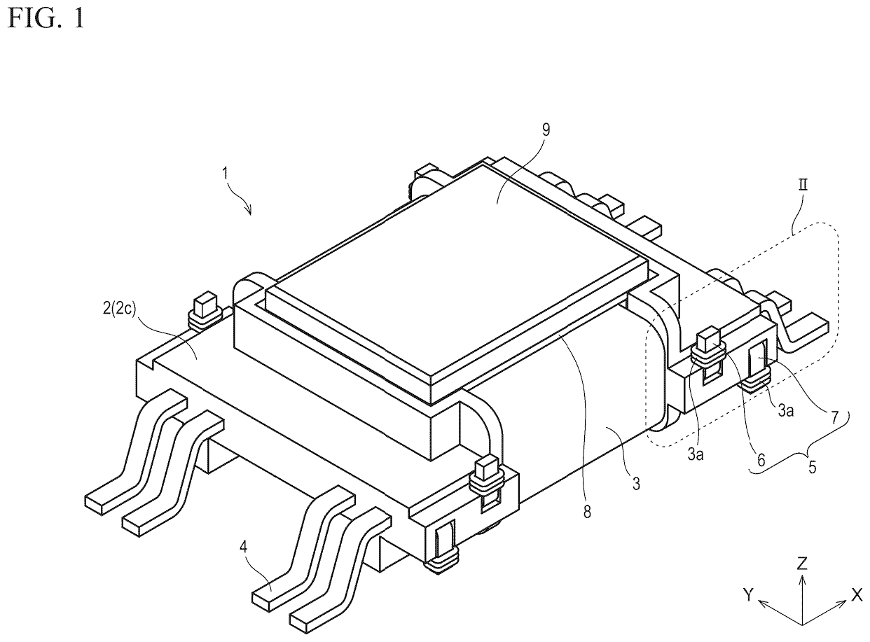

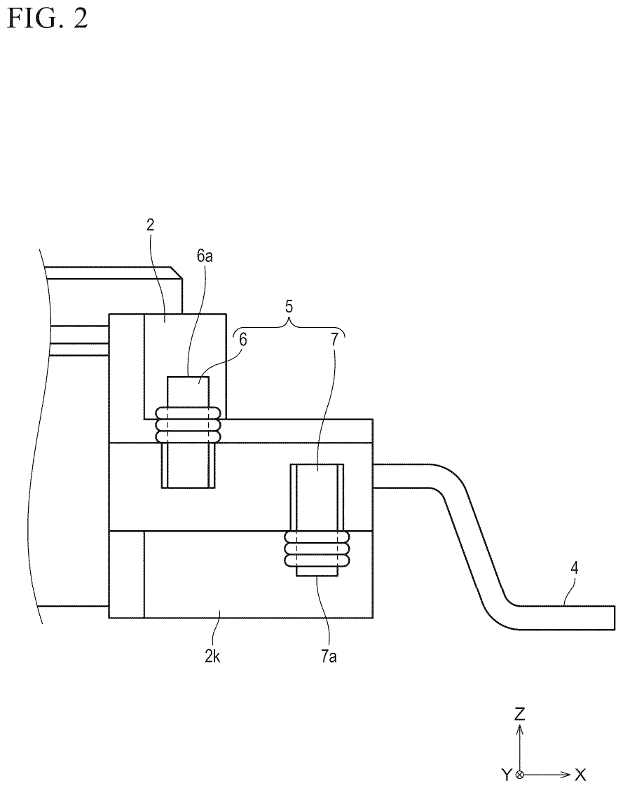

First, a surface mount coil component (surface mount transformer 1) will be outlined, mainly referring to FIGS. 1 and 2.

FIG. 1 is a perspective view illustrating a surface mount transformer 1 of this embodiment, and FIG. 2 is an enlarged view of part II in FIG. 1, illustrating adjacent entwined terminals 5 (6, 7).

Note that FIG. 1 and so forth do not depict draw lines that indicate boundaries between the loops wound around a bobbin 2.

Also note that the adjacent entwined terminals 6, 7 will also be collectively referred to as the entwined terminals 5.

The surface mount coil component (surface mount transformer 1) has winding 3 having lead sections 3a; an insulating bobbin 2 having a winding base 2a for the winding 3; a plurality of mounting terminals 4 protruded out from the bobbin 2; and a plurality of entwined terminals 5 (6, 7) formed of the same member with the individual mounting terminals 4, around which the lead sections 3a of the winding are wound.

The adjacent entwined terminals of the plurality of (two, in this embodiment) entwined terminals 6, 7 are bent facing to a direction of protrusion from the bobbin 2. The lead sections 3a are wound around the bent parts of the entwined terminals 5 (6, 7).

This embodiment will explain the surface mount transformer 1, which is an equivalent of the surface mount coil component.

The “surface mount coil component” is, however, not limited to the surface mount transformer 1, and may only be a component having the lead sections 3a to be wound at least around the adjacent entwined terminals 5 (6, 7), such as coupling inductor, antenna, or the like.

In a particular case where the entwined terminals 5 are arranged side by side on the same pole side, such entwined terminals 5 arranged side by side may be contacted.

While this embodiment will be explained with reference to a case where two (a pair of) adjacent entwined terminals 6, 7 are provided, three or more terminals may also be provided.

In this embodiment, the direction of protrusion of the mounting terminals 4 out from the bobbin 2 is laid in the longitudinal direction (X direction) of the surface mount transformer 1, whereas the direction of protrusion of the entwined terminals 5 out from the bobbin 2 is laid in the crosswise direction (Y direction) of the surface mount transformer 1.

The present invention is, however, not limited to this structure, allowing the direction of protrusion of the entwined terminals 5 laid in the same direction the mounting terminals 4 protrude.

With the entwined terminals 5 bent facing to a direction of protrusion from the bobbin 2, this structure can contribute to downsize the surface mount transformer 1.

### <Structure>

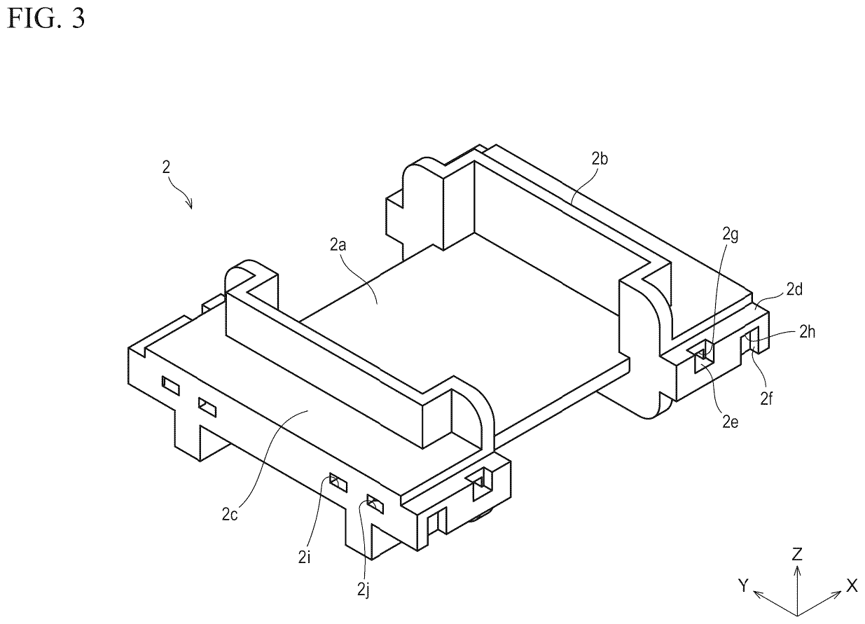

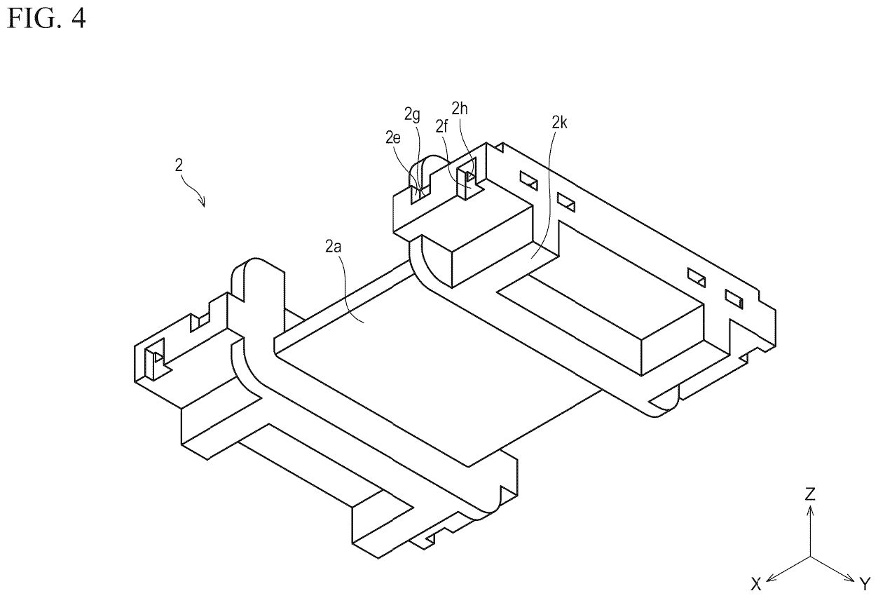

Next, a structure of the surface mount transformer 1 of this embodiment will be explained, while referring to FIGS. 1 and 2, as well as FIGS. 3 and 4.

FIG. 3 is a top perspective view illustrating the bobbin 2, and FIG. 4 is a bottom perspective view illustrating the bobbin 2.

The surface mount transformer 1 of this embodiment has the bobbin 2 having the winding base 2a, an unillustrated U-core as a magnetic material core placed on the winding base 2a, the winding 3 which is wound around the U-core and the winding base 2a, and an I-core 9 attached to the winding 3 while placing a gap sheet 8 in between, as the major components.

### [Bobbin]

The bobbin 2 has, as illustrated in FIGS. 3 and 4, the winding base 2a shaped in a flat plate; upright walls 2b and ribs 2k that extend upwards (+Z direction) and downwards (−Z direction), respectively, from both ends in the longitudinal direction (X direction) of the winding base 2a; and side terraces 2c that form both ends, in the longitudinal direction, of the bobbin 2 outside of the upright walls 2b, as the major components.

Each of the side terraces 2c on both ends, in the longitudinal direction, has a swelled side terrace 2d that swells from both sides in the crosswise direction (Y direction) of the bobbin 2, at a level lower than each side terrace 2c.

A face of (the swelled side terrace 2d of) the bobbin 2, from which the entwined terminals 5 (6, 7) protrude, has formed therein a plurality of recessed notches 2e, 2f into which the bent parts of the adjacent entwined terminals 6, 7 are fit.

Denoting now the adjacent recessed notches 2e, 2f, out of the plurality of notches 2e, 2f, as a first recessed notch 2e and a second recessed notch 2f, the first recessed notch 2e is opened in either one of the directions (+Z direction) the bent parts of the adjacent entwined terminals 6, 7 extend. The second recessed notch 2f is opened in the other direction (−Z direction).

The bent parts of the adjacent entwined terminals 6, 7 are individually fitted to the first recessed notch 2e and the second recessed notch 2f. Each end of the adjacent entwined terminals 6, 7 is protruded from an opened part of the first recessed notch 2e or the second recessed notch 2f.

More specifically, the recessed notch 2e is formed at an upper edge of the bobbin 2, thereby being opened upwards (+Z direction) and outwards in the crosswise direction.

Similarly, the recessed notch 2f is formed at a lower edge of the bobbin 2, thereby being opened downwards (−Z direction) and outwards in the crosswise direction.

Now, the condition stating that “mutually in opposite directions, with reference to the direction of alignment” is defined to be satisfied, if at least either case described above applies to “opposite directions”. That is, assuming now a pair of entwined terminals 5 (6, 7) are aligned in the X direction, such pair of entwined terminals 5 (6, 7) are defined to apply to “mutually in opposite directions, with reference to the direction of alignment” if they have a +Z component and a −Z component, respectively, regardless of an Y component (that is, even if both of them had a −Y component).

Even if the direction of alignment of the pair of entwined terminals 5 (6, 7) crossed obliquely to the X direction, Y direction or Z direction, it suffices that the entwined terminals 5 (6, 7) extend in the plus direction and the minus direction in any axis orthogonal to the direction of alignment.

With this structure, the recessed notches 2e, 2f can properly support the bent parts of the adjacent entwined terminals 5 that extend mutually in opposite directions, with reference to the direction of alignment, as described later.

As illustrated in FIGS. 3 and 4, each recessed notch 2e provided on the inner side in the longitudinal direction has formed therein an entwined terminal hole 2g through which the entwined terminal 6 is inserted, meanwhile each recessed notch 2f provided on the outer side has formed therein an entwined terminal hole 2h through which the entwined terminal 7 is inserted.

At the outer end face, in the longitudinal direction, of each side terrace 2c, there are provided mounting terminal holes 2i, 2j through which the mounting terminals 4 described later are inserted.

The mounting terminal holes 2i, 2j are provided, while arranged side by side in the crosswise direction (Y direction) and paired at each of four corners of the bobbin 2. The mounting terminal hole 2i on the inner side in the crosswise direction communicates with the entwined terminal hole 2g on the inner side in the longitudinal direction (X direction), meanwhile, the mounting terminal hole 2j on the outer side in crosswise direction communicates with the entwined terminal hole 2j on the outer side in the longitudinal direction (X direction).

The ribs 2k are, as illustrated in FIG. 4, formed on the lower face of the bobbin 2 on both sides in the longitudinal direction (X direction) while placing the winding base 2a in between, so as to protrude downwards to form a shape of right-angled gate just like Japanese “torii”. The ribs 2k, extended downwards beyond the entwined terminals 7 described later, can stabilize a state of mounting of the surface mount transformer 1 when mounted on an unillustrated printed board.

### [Entwined Terminal]

The entwined terminals 5 (entwined terminals 6, 7) are articles around which the lead sections 3a, which are the ends of the winding 3, are wound for electrical connection, and are formed integrally with the mounting terminals 4 described later.

The lead sections 3a are individually wound around the entwined terminals 5, and then joined to the entwined terminals 5 by welding or soldering.

Each entwined terminal 5 in this embodiment has a size of 0.7 mm in the longitudinal direction (X direction), and a size of 0.3 mm in the crosswise direction (Y direction).

In this embodiment, the entwined terminals 6, 7 are paired and arranged at each of four corners of the surface mount transformer 1. That is, the paired entwined terminals are provided so as to assign two pairs on the primary side (−X direction side) and two pairs on the secondary side (+X direction side), totaling eight terminals.

The structure is, however, not limited thereto, wherein the number of the entwined terminals 5 is freely selectable.

The plurality of adjacent entwined terminals 6, 7 are, as illustrated in FIG. 2, bent mutually in different directions (+Z directions in this embodiment) in which their end parts 6a, 7a are separated from each other.

In this embodiment, the entwined terminals 6, 7 are bent in opposite directions (turned 180°), when viewed in the direction they protrude out from the bobbin 2 (when viewed in the Y direction in FIG. 2). The present invention is, however, not limited to such structure.

More specifically, the phrase stating that “mutually in different directions” is defined to indicate directions away at an angle of at least 45° or larger and 315° or smaller, when viewed in the direction the entwined terminals 6, 7 protrude, or viewed in the direction orthogonal to the direction of protrusion (viewed in the X direction or the Z direction).

With such structure in which the entwined terminals 6, 7 are bent in different directions in which their end parts 6a, 7a are separated from each other, winding operation with an unillustrated winding machine onto the one entwined terminal 6 is prevented from being interfered by the neighboring entwined terminal 7.

In addition, with the plurality of entwined terminals 6, 7 bent mutually in different directions (non-interfering directions) in which their end parts 6a, 7a are separated from each other, it now becomes possible to narrow a pitch between the entwined terminals 6, 7 (in other words, the distance between the roots of protrusion of the entwined terminals 6, 7 out from the bobbin 2).

For example, the entwined terminals 6, 7 may protrude out from the bobbin 2, at the same position in the longitudinal direction (X direction) and in the crosswise direction (Y direction), so far as they are shifted in the height direction (Z direction). With such structure, the pitch between the entwined terminals 6, 7 may be narrowed both in the longitudinal and crosswise directions, thereby enabling downsizing of the surface mount transformer 1 per se.

The adjacent entwined terminals 6, 7 are bent mutually in opposite directions (Z direction, in this embodiment), with reference to the direction of alignment of the entwined terminals 6, 7 (X direction, in this embodiment).

With such structure featured by the bending mutually in opposite directions with reference to the direction of alignment, the entwined terminals 6, 7 can further bring their end parts apart.

The adjacent entwined terminals 6, 7 protrude out from the bobbin at the same level of height, and the entwined terminals 6, 7 are bent mutually in vertically opposite directions.

Now, the “level of height” is defined by a distance in the vertical direction from a virtual mounting plane which is defined by the end parts of three or more mounting terminals 4.

The “same level of height” is defined to encompass not only perfectly-matched height, but also overlapping of the entwined terminals 6, 7 in the height direction (in other words, difference of level of height, measured at the center of thickness, between these two entwined terminals 6, 7 is smaller than the thickness of the entwined terminals).

With such structure in which the entwined terminals 6, 7 protrude at the same level of height, it now becomes possible to reduce the thickness of (the side terraces 2c of) the bobbin 2 that supports the root parts of the entwined terminals 6, 7 after guided through the entwined terminal holes 2g, 2h. The entwined terminals 6, 7, which were bent in vertically opposite directions, can be vertically laid on the side face of the bobbin 2 (side terraces 2c).

The entwined terminals 6, 7 may, however, protrude out from the bobbin 2 at different levels of height, without being limited to the aforementioned structure.

In particular, the entwined terminals 5 are bent at 90°, facing to the direction of protrusion from the bobbin 2 (Y direction).

More specifically, the entwined terminal 6 is bent at +90°, facing to the direction of protrusion from the bobbin 2, meanwhile the entwined terminal 7 is bent at −90°, facing to the direction of protrusion from the bobbin 2, when viewed in the longitudinal direction of the bobbin 2 (X direction).

With such structure, the entwined terminals 5 may be suppressed from largely protruding from the bobbin 2 in the direction of protrusion.

Of the adjacent entwined terminals 6, 7, the inner one of them (in this embodiment, the entwined terminal 6 arranged on the inner side in the longitudinal direction) is bent in an opposite direction (+Z direction) from a mounting direction (−Z direction), meanwhile the outer one (in this embodiment, the entwined terminal 7 arranged on the outer side in the longitudinal direction) is bent in the mounting direction (−Z direction).

The surface mount coil component (surface mount transformer 1) usually has the winding 3 and the core (I-core 9) protruded in the central area in the opposite direction (+Z direction) from the mounting direction and has the mounting terminals 4 protruded in the peripheral area in the mounting direction (−Z direction).

This structure, having the entwined terminal 7 laid along these components (winding 3, I-core 9, and mounting terminal 4), can contribute to downsize the surface mount coil component.

### [Mounting Terminal]

The mounting terminals 4 are used for mount the surface mount transformer 1 on an unillustrated board by soldering, and are provided so as to assign two pairs on the primary side (−X direction side) and two pairs on the secondary side (+X direction side), totaling eight terminals.

In this embodiment, at each of four corners of the surface mount transformer 1, the mounting terminal 4 on the inner side in the crosswise direction is formed integrally with the entwined terminal 6 on the inner side in the longitudinal direction, meanwhile the mounting terminal 4 on the outer side in the crosswise direction is formed integrally with the entwined terminal 7 on the outer side in the longitudinal direction.

The direction of protrusion (X direction) of the mounting terminal 4 out from the bobbin 2 is orthogonal, in a plan view (viewed in the Z direction), to the direction of protrusion (Y direction) of the entwined terminals 6, 7 out from the bobbin 2. This structure can suppress the entwined terminals 6, 7, when wound with a nozzle of a winder in the winding operation, from being interfered with the mounting terminal 4.

The gap sheet 8 is used for controlling the DC bias characteristics. The gap sheet 8 is made of a non-magnetic material and is inserted between the winding 3 and the I-core 9.

The aforementioned embodiments and modified examples encompass the technical spirits below.

(1)

A surface mount coil component that includes:
a winding having at least a lead section;
an insulating bobbin having a winding base for the winding;
a plurality of mounting terminals protruded out from the bobbin; and
a plurality of entwined terminals formed of the same member with the individual mounting terminals, around which the lead section of the winding is wound,
adjacent entwined terminals of the plurality of entwined terminals being bent facing to a direction of protrusion from the bobbin, and the lead section being wound around each bent part of each of the entwined terminals.

(2)

The surface mount coil component according to (1), wherein the adjacent entwined terminals are bent mutually in different directions in which their end parts are separated from each other.

(3)

The surface mount coil component according to (2), wherein the adjacent entwined terminals are bent mutually in opposite directions, with reference to the direction of alignment of the entwined terminals.

(4)

The surface mount coil component according to (3), wherein the adjacent entwined terminals protrude out from the bobbin at the same level of height, and
the entwined terminals are bent mutually in vertically opposite directions.

(5)

The surface mount coil component according to any one of (1) to (4), wherein a face of the bobbin from the which the entwined terminals protrude have formed therein a plurality of recessed notches into which the bent parts of the adjacent entwined terminals are fit,
denoting now the adjacent recessed notches out of the plurality of notches as a first recessed notch and a second recessed notch,
the first recessed notch is opened in either one of the directions the bent parts of the adjacent entwined terminals extends,
the second recessed notch is opened in the other direction, the bent parts of the adjacent entwined terminals being individually fitted to the first recessed notch and the second recessed notch, and
each end of the adjacent entwined terminals is protruded from an opened part of the first recessed notch or the second recessed notch.

(6)

The surface mount coil component according to any one of (1) to (5), wherein the entwined terminal is bent 90 degrees away from the direction of protrusion from the bobbin.

(7)

The surface mount coil component according to any one of (1) to (6), wherein the inner one out of the plurality of entwined terminals is bent in a direction opposite to a mounting direction, and the outer one is bent in the mounting direction.

### REFERENCE SIGNS LIST

1 surface mount transformer (surface mount coil component)
2 bobbin
   2a winding base
   2b upright wall
   2c side terrace
   2d swelled side terrace
   2e recessed notch (first recessed notch)
   2f recessed notch (second recessed notch)
   2g, 2h entwined terminal hole
   2i, 2j mounting terminal hole
   2k rib
3 winding
   3a lead section
4 mounting terminal
5, 6, 7 entwined terminal
   6a, 7a end part
8 gap sheet
9 I-core (plate-like magnetic core member)

1. A surface mount coil component comprising:
a winding having at least a lead section,
an insulating bobbin having a winding base for the winding,
a plurality of mounting terminals protruded out from the bobbin; and
a plurality of entwined terminals formed of the same member with the individual mounting terminals, around which the lead section of the winding is wound,
adjacent entwined terminals of the plurality of entwined terminals being bent facing to a direction of protrusion from the bobbin, and
the lead section being wound around each bent part of each of the entwined terminals.

2. The surface mount coil component according to claim 1, wherein the adjacent entwined terminals are bent mutually in different directions in which their end parts are separated from each other.

3. The surface mount coil component according to claim 2, wherein the adjacent entwined terminals are bent mutually in opposite directions, with reference to the direction of alignment of the entwined terminals.

4. The surface mount coil component according to claim 3, wherein the adjacent entwined terminals protrude out from the bobbin at the same level of height, and
the entwined terminals are bent mutually in vertically opposite directions.

5. The surface mount coil component according to claim 1, wherein a face of the bobbin from the which the entwined terminals protrude have formed therein a plurality of recessed notches into which the bent parts of the adjacent entwined terminals are fit,
denoting now the adjacent recessed notches out of the plurality of notches as a first recessed notch and a second recessed notch,
the first recessed notch is opened in either one of the directions the bent parts of the adjacent entwined terminals extend,
the second recessed notch is opened in the other direction, the bent parts of the adjacent entwined terminals being individually fitted to the first recessed notch and the second recessed notch, and
each end of the adjacent entwined terminals is protruded from an opened part of the first recessed notch or the second recessed notch.

6. The surface mount coil component according to claim 1, wherein the entwined terminal is bent 90 degrees away from the direction of protrusion from the bobbin.

7. The surface mount coil component according to claim 1, wherein the inner one out of the plurality of entwined terminals is bent in a direction opposite to a mounting direction, and the outer one is bent in the mounting direction.
